(19) United States
(12) Patent Application Publication
(10) Pub. No.: US 2023/0370574 A1
(43) Pub. Date: Nov. 16, 2023

(54) BUFFER ARRANGEMENT FOR USE IN A LISSAJOUS SCANNING PROJECTION SYSTEM

(71) Applicants: HUAWEI TECHNOLOGIES CO., LTD., Shenzhen (CN); FRAUNHOFER GESELLSCHAFT ZUR FOERDERUNG DER ANGEWANDTEN FORSCHUNG E.V., Muenchen (DE)

(72) Inventors: Peter BLICHARSKI, Itzehoe (DE); Thomas Von WANTOCH, Itzehoe (DE); Oleg PETRAK, Itzehoe (DE); Marcel REHER, Itzehoe (DE); Aloshious Thottappattu JOY, Itzehoe (DE); Yong CAO, Munich (DE)

(21) Appl. No.: 18/316,720

(22) Filed: May 12, 2023

Related U.S. Application Data
(63) Continuation of application No. PCT/EP2020/082082, filed on Nov. 13, 2020.

(51) Int. Cl. H04N 9/31; G06T 1/20; G02B 26/10; G03B 21/00

(52) U.S. Cl. CPC H04N 9/3129; G06T 1/20; G02B 26/101; G03B 21/008

(57) ABSTRACT

A buffer arrangement for providing pixel information in a Lissajous scanning projection system is provided. The projection system includes a memory, a MEMS mirror, a projection unit, and a data unit. The memory includes a projection buffer and a shadow buffer. An incoming stream of pixel information scanned from the MEMS mirror is written to the shadow buffer. The incoming stream of pixel information is forwarded to the projection buffer. The projection buffer forwards the incoming stream of pixel information to the projection unit. The projection unit projects the incoming stream of pixel information based on the Lissajous pattern through a mirror projector trajectory. The shadow buffer and the projection buffer operate at different frequencies.

### TECHNICAL FIELD

The present application relates to a projection system, and more particularly to a buffer arrangement and a method for providing pixel information to a Lissajous scanning projection system.

### DESCRIPTION OF THE RELATED ART

A projector is an optical device that receives an imaging signal and projects corresponding still images or moving images onto a screen In general, there are two classes of projectors such as Cathode ray tube (CRT) projectors and scanning projectors. The CRT based projection systems are rapidly losing their market and are only used in a few specialized applications. Scanning projectors were proposed soon after the laser was invented but they are now reaching commercial production.

Scanned projectors use scanned light beams that are created by MEMS (micro-electro-mechanical system) mirrors for displaying images or videos. Most of the projection systems are raster scan-based projection systems. These systems are optimized to support the raster scanning. The raster scan-based projectors use a sinusoidal drive on one or both axes for scanning. In raster scanning, the fast axis of the micromirror oscillates at the resonance frequency while the slow axis performs a non-resonant motion to scan light line by line. The raster scanning laser projector has a slow-scanning frequency. The frame rate is subject to the slow scanning frequency, which needs to be increased up to the persistence of human vision for real-time imaging. The raster scanning laser projector requires a large operating voltage for the slow-motion to achieve enough field-of-view in static mode.

Existing projection systems are getting the pixel information for projection via a prebuffered memory such as RAM of the same size as the resolution of the pixel information. In any scanned projectors, the resolution of the pixels is limited by the size of the memory (RAM). As the RAM size is limited, the support for high resolution is also limited. This is because, the interface frequency needed to write the pixels into the memory at high frame rates. Further, the existing projection systems are optimized for raster scanning only. In contrast to raster scanning projection, there is currently no solution available for Lissajous based scanning projection.

Therefore, there arises a need to address the aforementioned technical drawbacks in existing technologies in providing pixel information to the projection system.

### SUMMARY

It is an object of the present disclosure to provide an architecture and a method for providing pixel information to a projector unit that is independent of a resolution of input pixel information and able to process the pixel information at high frame rates.

This object is achieved by features of the independent claims. Further implementation forms are apparent from the dependent claims, the description, and the figures. According to a first aspect, a buffer arrangement for use in a projection system is provided, in which a MEMS mirror is used to project frames of pixels, having a frame size, onto a projection unit, following a mirror projector trajectory according to a Lissajous pattern, the MEMS mirror being controlled at a first clock frequency, said buffer arrangement comprising a projection buffer and a shadow buffer. The shadow buffer is arranged to receive an incoming stream of pixel data from a data unit operating at a second clock frequency, the writing to the shadow buffer being controlled at the second clock frequency. The projection buffer is arranged to receive pixel data from the shadow buffer and provide pixel data to the projection unit in the order of the mirror projection trajectory, the projection buffer being controlled at the first clock frequency, wherein the first clock frequency is adaptive. The shadow buffer is arranged to receive the pixel data in the order of the mirror projection trajectory.

According to a second aspect, a projector device for augmented reality or virtual reality, comprises a projection unit, a MEMS mirror for projecting frames of pixels onto the projection unit according to a Lissajous pattern, and a buffer arrangement according to the first aspect for providing pixel data to the projection unit reflected by the MEMS mirror.

According to a third aspect, a method of providing frames of pixels to a projection unit, is provided, each frame having a frame size. The method comprises providing the pixels to the projection unit in a Lissajous pattern at a first clock frequency, and the further steps of writing an incoming stream of pixel data from a data unit operating at a second clock frequency, the writing to a shadow buffer being controlled at the second clock frequency, forwarding pixel data from the shadow buffer to a projection buffer at the first clock frequency, which is adaptive, providing pixel data from the projection buffer to the projection unit, in the order of the mirror projection trajectory, wherein the shadow buffer is arranged to receive the pixel data in the order of the mirror projection trajectory.

A technical problem in the prior art is resolved, where the technical problem is that the resolution is limited by memory size and support for high resolution is limited, because of the interface frequency needed to write the pixels into the memory at high framerates.

In a first possible implementation form, the buffer arrangement according to the first aspect includes a feedback unit arranged to detect a position of the MEMS mirror and send information about the position to the data unit to control the order of the pixel data sent to the shadow buffer. Accordingly, the method may comprise detecting a position of the MEMS mirror and sending information about the position to the data unit to control the order of the pixel data sent to the shadow buffer.

In a second possible implementation form of the buffer arrangement according to the first aspect and the method according to the third aspect, the second clock frequency is selected in dependence of an average frequency of the adaptive first clock frequency.

The clock that generates the adaptive first clock frequency is on average slower than the maximum frequency value during scanning. Therefore, the second clock frequency that is responsible for filling the shadow buffer can be reduced according to the average first clock frequency and not the maximum frequency, relaxing the need for high-speed interfaces for filling pixels at a high frame rate.

In a third possible implementation form of the buffer arrangement according to the first aspect and the method according to the third aspect, the projection buffer and the shadow buffer are smaller than the frame size.

The size N of the projection buffer and the shadow buffer is only a fraction of the total resolution of a single frame to be projected and not defined by the resolution of pixels of the frames, that allows selecting the size of the projection buffer and the shadow buffer freely. Optionally, the size of the projection buffer and the shadow buffer has a positive effect on the interface speed of filling the frames of pixels in the buffer.

In a fourth possible implementation form of the buffer arrangement according to the first aspect and the method according to the third aspect, the projection buffer and the shadow buffer have the same size.

In a fifth possible implementation form of the buffer arrangement according to the first aspect and the method according to the third aspect, the data unit is a frame buffer such as a graphics processor unit—GPU. Optionally, the data unit is a microcontroller (MCU) or a digital signal processor (DSP).

In a sixth possible implementation form of the buffer arrangement according to the first aspect and the method according to the third aspect, the step of forwarding pixel data from the shadow buffer to the projection buffer is performed for all N-elements of the shadow buffer in parallel in between the projection of the two pixels. The pixel modification may not be visible and it avoids flickering or screen flashes.

These and other aspects of the present disclosure will be apparent from and the embodiment(s) described below.

### BRIEF DESCRIPTION OF DRAWINGS

To illustrate the technical solutions in the embodiments of the present disclosure or the prior art more clearly, the following briefly introduces the accompanying drawings required for describing the embodiments of the prior art. Apparently, the accompanying drawings in the following description show merely some embodiments of the present disclosure, and a person of ordinary skill in the art may still derive other drawings from these accompanying drawings without creative efforts.

FIG. 1 is a block diagram of a buffer arrangement in a projection system in accordance with an embodiment of the present disclosure;

FIG. 2 is an interaction diagram of a method of providing frames of pixels to the projection system in accordance with an embodiment of the present disclosure;

FIG. 3 is a flow diagram of a method of providing frames of pixels to the projection system in accordance with an embodiment of the present disclosure; and

FIG. 4 illustrates an exemplary system in which the various architecture and/or functionality of the various previous embodiments may be implemented.

### DETAILED DESCRIPTION

Embodiments of the present disclosure provide a method for providing pixel information to a Lissajous scanning projection system and related apparatuses for hardware resources for the projection system to optimize the resolution of the output irrespective of the resolution of the input and to process content at high frame rates for video projection.

To make the solutions of the present disclosure more comprehensible for a person skilled in the art, the following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

Terms such as “a first”, “a second”, “a third”, and “a fourth” (if any) in the summary, claims, and foregoing accompanying drawings of the present disclosure are used to distinguish between similar objects and are not necessarily used to describe a specific sequence or order. It should be understood that the terms so used are interchangeable under appropriate circumstances, so that the embodiments of the present disclosure described herein are, for example, capable of being implemented in sequences other than the sequences illustrated or described herein. Furthermore, the terms “include” and “have” and any variations thereof, are intended to cover a non-exclusive inclusion. For example, a process, a method, a system, a product, or a device that includes a series of steps or units, is not necessarily limited to expressly listed steps or units, but may include other steps or units that are not expressly listed or that are inherent to such process, method, product, or device.

In order to help understand embodiments of the present disclosure, several terms that will be introduced in the description of the embodiments of the present disclosure are defined herein first.

MEMS (micro electro mechanical system) mirror reflects an electromagnetic wave radiated from a light source while changing an angle of a reflection surface thereof. In general, MEMS-based mirror deflects in both static and dynamic operations. Field of View (FOV) is a display area of a virtual picture in a display screen. Projection Unit (PU) is an image projector that receives a video signal and projects the corresponding video signal on a projection screen using a lens system.

The following describes the architecture of the Lissajous scan-based projection system that is capable of implementing solutions in embodiments of the present disclosure.

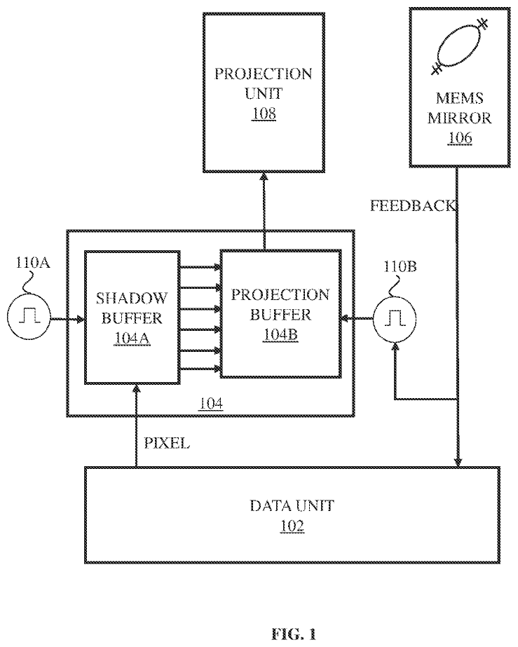

FIG. 1 is a block diagram of a buffer arrangement 104 for use in a projection system in accordance with an embodiment of the present disclosure. The buffer arrangement 104 may present in a memory. The buffer arrangement 104 for use in the projection system illustrated in FIG. 1 includes a shadow buffer 104A that receives an incoming stream of pixel information from a data unit 102 and a projection buffer 104B that receives the incoming stream of pixel information from the shadow buffer 104A. The projection buffer 104B is controlled at a first clock frequency 110B and the shadow buffer 104A is controlled at a second clock frequency 110A. The first clock frequency 110B is adaptive. The second clock frequency 110A may be selected in dependence of an average frequency of the adaptive first clock frequency. The shadow buffer 104A is arranged to receive an incoming stream of pixel data from a data unit 102.

The projection buffer 104B is arranged to forward the pixel data to a projection unit 108 through a MEMS mirror 106.

The MEMS mirror 106 is arranged to receive pixel information from the projection buffer 104B and project it onto the projection unit 108.

The shadow buffer 104A receives the stream of the pixel information from the data unit 102 in an order of a mirror projection trajectory. The data unit 102 operates at the second clock frequency 110A.

In the embodiment shown in FIG. 1, the MEMS mirror 106 is arranged to send information about the position of the MEMS mirror 106 to the data unit 102 to control the order of the pixel data that sent to the shadow buffer 104A. Because the pixels are written to the buffer in the order in which they are to be projected, the projection buffer 104B and the shadow buffer 104A may be smaller than the frame size. The projection buffer 104B and the shadow buffer 104A may have the same size. In an embodiment, therefore, the projection buffer 104B and the shadow buffer 104A of size N store only a part of the current frame to be projected. The size N is only a fraction of the total resolution of a single frame and not defined by the resolution. The size N can be selected freely. In an embodiment, the projection buffer 104B and the shadow buffer 104A provide a data stream without any breaks. In an embodiment, the projection buffer 104B is filled with pre-loaded pixel data from the shadow buffer 104A. In an embodiment, the projection buffer 104B is filled in between the projection of two pixels for the stream of the pixel information. In an embodiment, filling of the pre-loaded pixel data improves the stream of the pixel data at high frame rates without any breaks. The resolution of the pixels is high as the frame rate is high.

The data unit 102 may include a random-access memory that reads the pixel data to be projected. In an embodiment, the data unit 102 has the same size as the resolution of the projection unit 108. The resolution of the projection unit 108 is the number of distinct pixels in each dimension of FOV.

The MEMS mirror 106 is typically a dual-axis mirror, for example, may be a micro-scanner, etc. The MEMS mirror 106 may be connected to a laser driver. The mirror trajectory path is a path followed by the reflection of the stream of pixel information. The trajectory may be a sinusoidal horizontal trajectory. The data unit 102 provides a control signal to drive the MEMS mirror 106 at the second clock frequency 110A, for example, a frequency at which a pattern is projected, for example, a Lissajous pattern. Upon receiving the control signal, the data unit 102 generates a field, for example, a magnetic field, or an electric field, etc. to control the movement of the MEMS mirror 106. The MEMS mirror 106 may be a two-dimensional 2D MEMS mirror or 2×1D MEMS mirror. In an embodiment, a feedback unit is arranged to detect a position of the MEMS mirror 106.

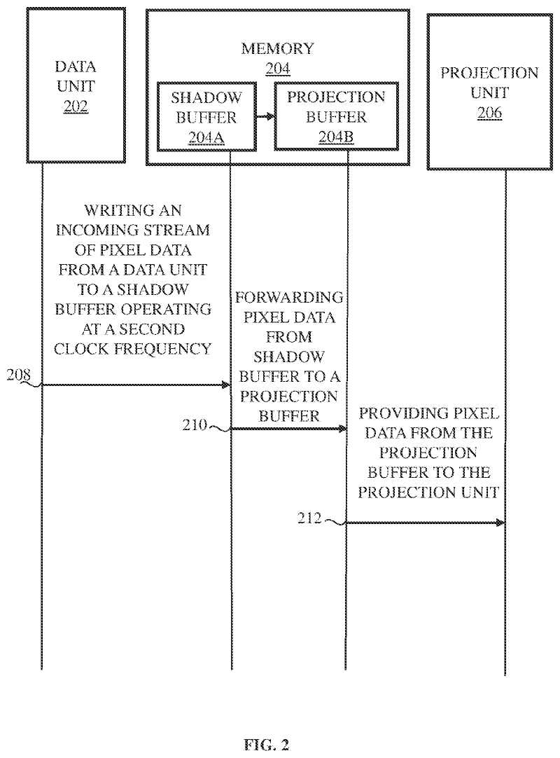

FIG. 2 is an interaction diagram of a method of providing frames of pixels to a projection system in accordance with an embodiment of the present disclosure. At step 208, the method includes writing an incoming stream of pixel data from a data unit 202 to a memory 204. The memory 204 includes a shadow buffer 204A operating at a second clock frequency, that receives the incoming stream of the pixel data from the data unit 202.

At step 210, the method includes, forwarding pixel data from the shadow buffer 204A to a projection buffer 204B. The shadow buffer 204A forwards the incoming stream of pixel data to the projection buffer 204B at the order of the mirror projection trajectory. The projection buffer 204B is controlled at a first clock frequency, which is adaptive. At step 212, the method includes providing pixel data from the projection buffer 204B to a projection unit 206. The projection buffer 204B and the shadow buffer 204A of size N may store only a part of the current frame to be projected. The size N can be selected freely. The projection buffer 204B is controlled at the first clock frequency. The first clock frequency is adaptive.

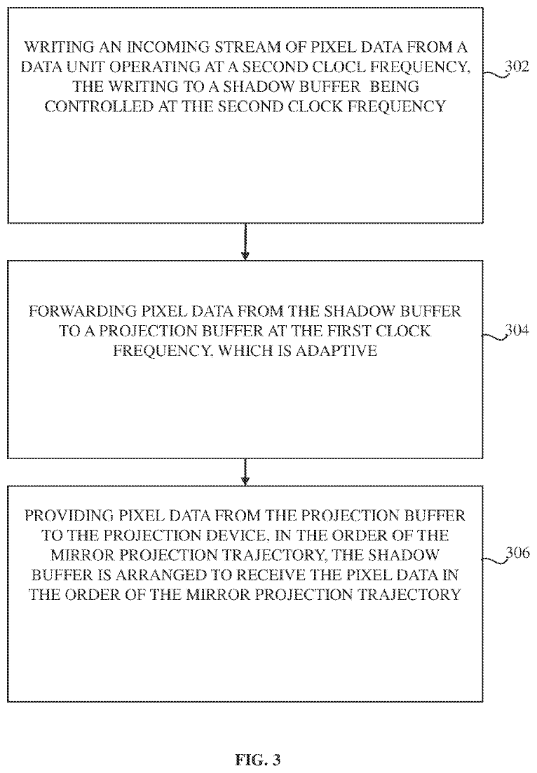

FIG. 3 is a flow diagram of a method of providing frames of pixels to a projection system in accordance with an embodiment of the present disclosure. At step 302, the method includes writing an incoming stream of pixel data from a data unit operating at a second clock frequency, the writing to a shadow buffer being controlled at the second clock frequency.

At step 304, the method includes forwarding pixel data from the shadow buffer to a projection buffer at a first clock frequency, which is adaptive. The shadow buffer forwards the incoming stream of pixel data to the projection buffer. The projection buffer receives the stream of the pixel information from the shadow buffer according to the mirror projection trajectory. In an embodiment, the projection buffer and the shadow buffer are smaller than the frame size. The projection buffer and the shadow buffer may have the same size. At step 306, the method includes providing pixel data from the projection buffer to the projection unit, in the order of the mirror projection trajectory. The size N can be selected freely and may be smaller than the frame size. A buffer arrangement method and related apparatuses for a method of Lissajous scan-based projection and related apparatuses for hardware resources for the projection system that is provided by the embodiments of the present disclosure are described in detail above.

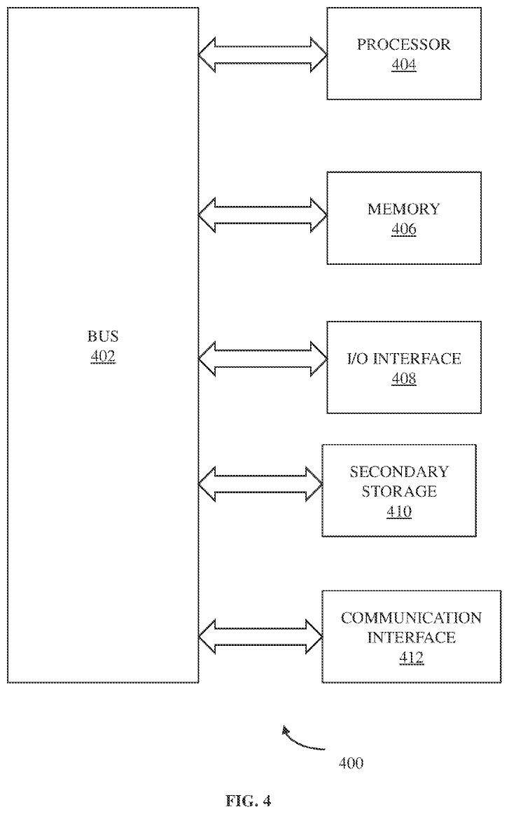

FIG. 4 illustrates an exemplary system 400 in which the various architecture and/or functionality of the various previous embodiments may be implemented. As shown, the system 400 is provided including at least one processor 404 that is connected to a communication bus 402 may be implemented using any suitable protocol, such as PCI (Peripheral Component Interconnect), PCI-Express, AGP (Accelerated Graphics Port), HyperTransport, or any other bus or point-to-point communication protocol(s). The system 400 also includes a memory 406.

Control logic (software) and data are stored in the memory 406 which may take the form of random-access memory (RAM). In the present description, a single semiconductor platform may refer to a sole unitary semiconductor-based integrated circuit or chip. It should be noted that the term single semiconductor platform may also refer to multi-chip modules with increased connectivity which simulate on-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 400 may also include a secondary storage 410. The secondary storage 410 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the memory 406 and/or the secondary storage 410. Such computer programs, when executed, enable the system 400 to perform various functions. The memory 406, the secondary storage 410, and/or any other storage are possible examples of computer-readable media.

In an embodiment, the architecture and/or functionality of the various previous figures may be implemented in the context of the processor 404, a graphics processor coupled to communication interface 412, an integrated circuit (not shown) that is capable of at least a portion of the capabilities of both the processor 404 and a graphics processor, a chipset (i.e., a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 400 may take the form of a desktop computer, laptop computer, server, workstation, game consoles, embedded system, and/or any other type of logic.

Still yet, the system 400 may take the form of various other devices including, but not limited to a personal digital assistant (PDA) device, a mobile phone device, a television, etc. Further, while not shown, the system 400 may be coupled to a network (e.g., a telecommunications network, local area network (LAN), wireless network, wide area network (WAN) such as the Internet, peer-to-peer network, cable network, or the like) for communication purposes through an I/O interface 408.

It should be understood that the arrangement of components illustrated in the figures described are exemplary and that other arrangement may be possible. It should also be understood that the various system components (and means) defined by the claims, described below, and illustrated in the various block diagrams represent components in some systems configured according to the subject matter disclosed herein. For example, one or more of these system components (and means) may be realized, in whole or in part, by at least some of the components illustrated in the arrangements illustrated in the described figures.

In addition, while at least one of these components are implemented at least partially as an electronic hardware component, and therefore constitutes a machine, the other components may be implemented in software that when included in an execution environment constitutes a machine, hardware, or a combination of software and hardware.

Although the present invention and its advantages have been described in detail, it should be understood that various changes, substitutions and alterations can be made herein without departing from the spirit and scope of the invention as defined by the appended claims.

1. A buffer arrangement for use in a projection system in which a MEMS mirror is used to project frames of pixels, having a frame size, onto a projection unit, following a mirror projector trajectory according to a Lissajous pattern, the MEMS mirror being controlled at a first clock frequency, said buffer arrangement comprising:
a projection buffer and a shadow buffer,
the shadow buffer being arranged to receive an incoming stream of pixel data from a data unit operating at a second clock frequency, the writing to the shadow buffer being controlled at the second clock frequency,
the projection buffer being arranged to receive pixel data from the shadow buffer and provide pixel data to the projection unit in the order of the mirror projection trajectory, the projection buffer being controlled at the first clock frequency, wherein the first clock frequency is adaptive,
wherein the shadow buffer is arranged to receive the pixel data in the order of the mirror projection trajectory.

2. The buffer arrangement according to claim 1, further comprising a feedback unit arranged to detect a position of the MEMS mirror and send information about the position to the data unit to control the order of the pixel data sent to the shadow buffer.

3. The buffer arrangement according to claim 1, wherein the second clock frequency is selected in dependence of an average frequency of the adaptive first frequency.

4. The buffer arrangement according to claim 1, wherein the projection buffer and the shadow buffer are smaller than the frame size.

5. The buffer arrangement according to claim 1, wherein the projection buffer and the shadow buffer have the same size.

6. The buffer arrangement according to claim 1, wherein the data unit is a frame buffer such as a graphics processor unit, GPU.

7. A projector device for augmented reality or virtual reality, comprising a projection unit, a MEMS mirror for projecting frames of pixels onto the projection unit according to a Lissajous pattern, further comprising a buffer arrangement according to claim 1 for providing pixel data to the projection unit reflected by the MEMS mirror.

8. A method of providing frames of pixels to a projection unit, each frame having a frame size, comprising providing the pixels to the projection unit in a Lissajous pattern at a first clock frequency, the method comprising the steps of
writing an incoming stream of pixel data from a data unit operating at a second clock frequency, the writing to a shadow buffer being controlled at the second clock frequency,
forwarding pixel data from the shadow buffer to a projection buffer at the first clock frequency, which is adaptive,
providing pixel data from the projection buffer to the projection unit, in the order of the mirror projection trajectory,
wherein the shadow buffer is arranged to receive the pixel data in the order of the mirror projection trajectory.

9. The method according to claim 8, further the step of detecting, by means of a feedback unit, a position of the MEMS mirror and sending information about the position to the data unit to control the order of the pixel data sent to the shadow buffer.

10. The method according to claim 8, wherein the second clock frequency is selected in dependence of an average frequency of the adaptive first frequency.

11. The method according to claim 8, wherein the projection buffer and the shadow buffer are smaller than the frame size.

12. The method according to claim 8, wherein the projection buffer and the shadow buffer have the same size.

13. The method according to claim 8, wherein the data unit is a frame buffer such as a graphics processor unit—GPU.

14. The method according to claim 8, wherein the step of forwarding pixel data from the shadow buffer to the projection buffer is performed for all N-elements of the shadow buffer in parallel in between the projection of the two pixels.
